(19) United States
(12) Patent Application Publication
(10) Pub. No.: US 2026/0172678 A1
(43) Pub. Date: Jun. 18, 2026

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: ATSUYA KAWANISHI, Tokyo (JP)

(21) Appl. No.: 19/358,925

(22) Filed: Oct. 15, 2025

(30) Foreign Application Priority Data
Dec. 12, 2024 (JP) 2024-217738

(51) Int. Cl. H04N 23/67; H04N 23/61

(52) U.S. Cl. CPC H04N 23/672; H04N 23/61

(57) ABSTRACT

A control apparatus includes one or more memories storing instructions, and one or more processors that, upon execution of the instructions, operate to detect an object using a signal output from an image sensor, control a focus lens according to a focus state of the object, store a first position of the focus lens according to the focus state of the object in a first area, and move, in a case where the focus lens moves from the first position to a second position and the object moves outside the first area during imaging, the focus lens from the second position to the first position.

### BACKGROUND

### Field of the Technology

The disclosure relates to one or more embodiments of a control apparatus, an image pickup apparatus, a control method, and a storage medium.

### Description of the Related Art

Japanese Patent Application Laid-Open No. 2012-160855 discloses a method for moving a focus lens to a predetermined position in a case where it is detected that a preset object has entered a frame. Japanese Patent Application Laid-Open No. 2014-206640 discloses a method for moving a focus lens to an estimated position in a case where an object leaves the frame.

These methods disclosed in Japanese Patent Application Laid-Open Nos. 2012-160855 and 2014-206640 cannot improve the time lag or focus accuracy of the next image capturing (or imaging) in a case where images of a moving object are repeatedly captured.

### SUMMARY

One or more embodiments of a control apparatus according to one or more aspects of the disclosure may include one or more memories storing instructions, and one or more processors that, upon execution of the instructions, operate to detect an object using a signal output from an image sensor, control a focus lens according to a focus state of the object, store a first position of the focus lens according to the focus state of the object in a first area, and move, in a case where the focus lens moves from the first position to a second position and the object moves outside the first area during imaging, the focus lens from the second position to the first position. One or more image pickup apparatuses may include one or more control apparatuses in accordance with one or more other aspects of the disclosure. One or more control methods corresponding to the above one or more control apparatuses also constitute another aspect of the disclosure. A storage medium storing a program that causes a computer to execute the above one or more control methods also constitutes another aspect of the disclosure.

Features of the disclosure will become apparent from the following description of embodiments with reference to the attached drawings. The following description of embodiments will be described by way of example.

### BRIEF DESCRIPTION OF THE DRAWINGS

FIG. 1 is a block diagram of an imaging system according to each embodiment.

FIG. 2 is a timing chart according to a comparative example.

FIGS. 3A and 3B illustrate pixel arrangement on an image sensor according to each embodiment.

FIG. 4 is a flowchart of AF operation according to a first embodiment.

FIG. 5 is a flowchart of AF start position drive determination according to each embodiment.

FIG. 6 is a timing chart illustrating the effects of each embodiment.

FIG. 7 is a flowchart of focus detection processing in each embodiment.

FIG. 8 explains a focus detecting area in each embodiment.

FIGS. 9A, 9B, and 9C explain image signals in each embodiment.

FIGS. 10A and 10B explain a relationship between a shift amount and a correlation amount in each embodiment.

FIGS. 11A and 11B explain a relationship between a shift amount and a correlation change amount in each embodiment.

FIG. 12 is a flowchart of AF operation according to a second embodiment.

FIG. 13 is a timing chart illustrating the effects of the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

Before each embodiment is discussed, a comparative example will be presented to explain one of the problems in each embodiment. In repeatedly capturing images with a fixed composition, a focus position shifts significantly during imaging in scenes with large image plane movements, such as track events or trains. As a result, in a case where an object to be captured moves out of an angle of view, the camera will lose focus on no object and the entire image will become blurred. Hence, before starting capturing second or subsequent images, the camera may first again perform focusing on a different object and again perform framing. In a case where the interval until the next shot is short and there is no time to again perform focus, the camera may again perform focusing from a blurred state, resulting in a time lag and reduced focusing accuracy.

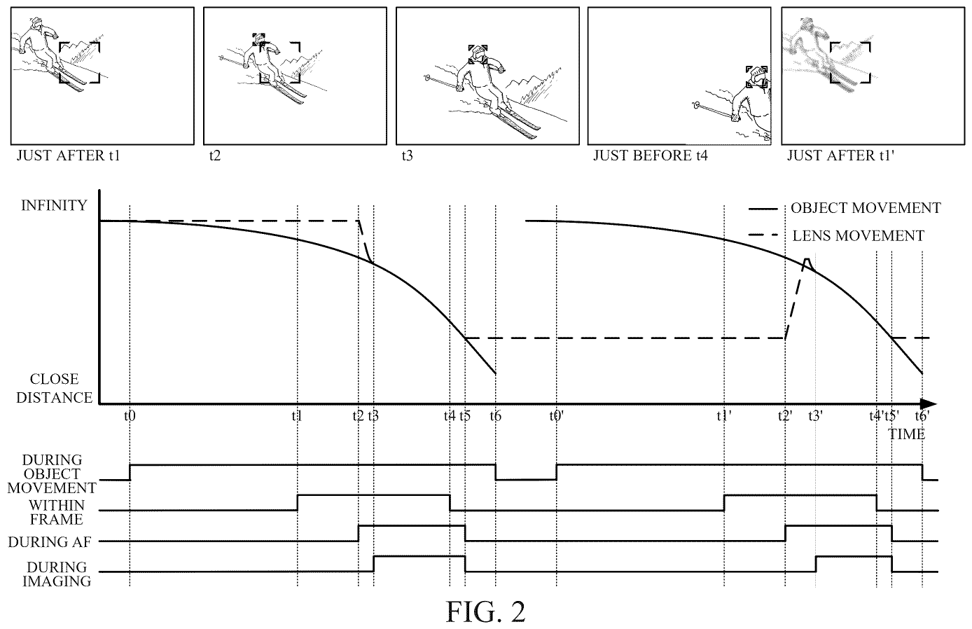

FIG. 2 illustrates a comparative example, illustrating the movements of the object and lens over time. Assume that the object being captured starts moving at time t0 and then enters a field of view (and a frame) at time t1. Typically, a user starts an autofocus (AF) operation when the object enters a focus detecting frame at time t2, and then starts imaging (capturing an image) when the object is in focus at time t3. When the object leaves the field of view (goes out of frame) at time t4, imaging and AF operation end. At this point, the AF operation is stopped while the focus lens has moved significantly toward a close distance. Therefore, when the object reenters the field of view at time t1′, the AF operation starts from a significantly blurred state, and a time lag occurs, and the focus accuracy deteriorates, as described above.

Embodiments according to the disclosure will be described in detail below.

### First Embodiment

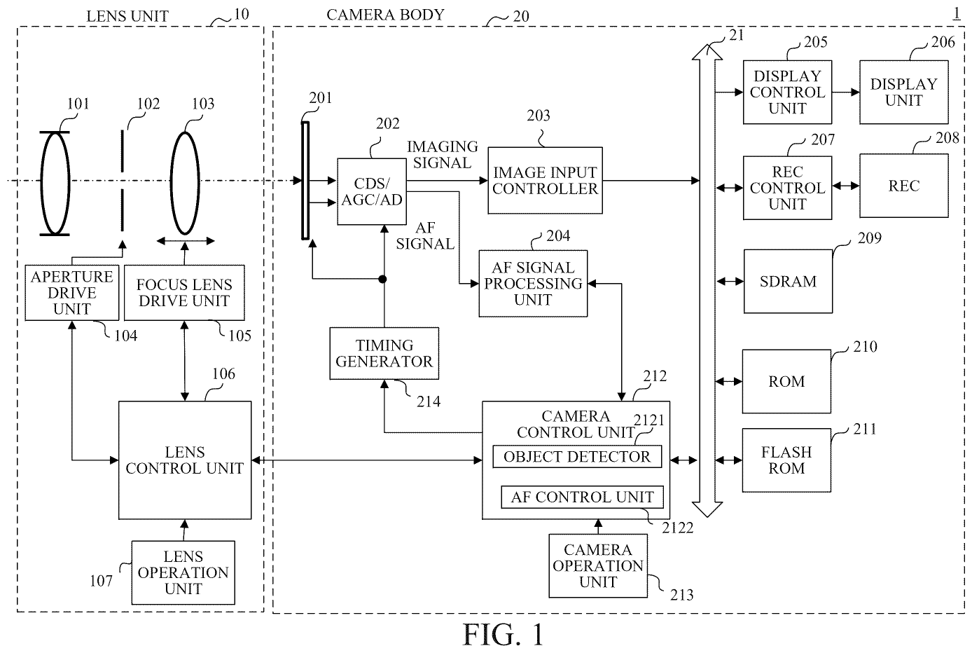

Referring now to FIG. 1, a description will be given of an imaging system 1 according to a first embodiment of the disclosure. The imaging system 1 is a lens interchangeable type camera system that includes a camera body (image pickup apparatus) 20 and a lens unit (lens apparatus) 10 attachable to and detachable from the camera body 20. A lens control unit 106, which controls the overall operation of the lens, and a camera control unit (control apparatus) 212, which controls the overall operation of the camera system, including the lens unit 10, can communicate with each other via terminals provided on the lens mount. However, this embodiment is not limited to this example and can also be applied to an image pickup apparatus in which the camera body and lens unit are integrated.

First, the configuration of the lens unit 10 will be described. A fixed lens 101, an aperture stop (diaphragm) 102, and a focus lens 103 constitute the imaging optical system in the lens unit 10. The aperture stop 102 is driven by an aperture drive unit 104 and controls a light amount incident on an image sensor 201 (described later). The focus lens 103 is driven by a focus-lens drive unit 105, and the focal length of the imaging optical system changes according to the position of the focus lens 103. The aperture drive unit 104 and the focus-lens drive unit 105 are controlled by the lens control unit 106 and determine the aperture amount of the aperture stop 102 and the position of the focus lens 103, respectively.

A lens operation unit 107 is a group of input devices that allow the user to make a setting regarding an operation of the lens unit 10, such as switching between AF and MF (manual focus) modes, adjusting the position of the focus lens using MF, and setting an image stabilizing mode. When the lens operation unit 107 is operated, the lens control unit 106 performs control in accordance with the operation.

The lens control unit 106 controls the aperture drive unit 104 and focus-lens drive unit 105 in accordance with control commands and control information received from the camera control unit 212, which will be described later, and also transmits lens control information to the camera control unit 212.

Next, the configuration of the camera body 20 will be described. The camera body 20 is configured to acquire an image signal from a light beam that passes through the imaging optical system in the lens unit 10.

The image sensor 201 includes a photoelectric conversion element such as a CCD sensor or CMOS sensor. The light beam incident from the imaging optical system in the lens unit 10 forms an image on the light receiving surface of the image sensor 201 and is converted into signal charges corresponding to the amount of incident light by photodiodes provided in the pixels arranged in the image sensor 201. The signal charges accumulated in each photodiode are sequentially read out from the image sensor 201 as voltage signals corresponding to the signal charges, using drive pulses output by a timing generator 214 in accordance with commands from the camera control unit 212.

Each pixel of the image sensor 201 for this embodiment includes two (a pair) photodiodes A and B and one microlens provided for the pair of photodiodes A and B. Each pixel splits incident light using the microlens to form a pair of optical images on the pair of photodiodes A and B, which then output a pair of pixel signals (signals A and B) that are used as AF signals (described below). The imaging signal (signal A+B) can be acquired by adding the outputs of the pair of photodiodes A and B.

A pair of A signals and B signals output from the plurality of pixels are combined to acquire a pair of image signals as AF signals (focus detecting signals) for AF using an imaging-surface phase-difference detecting method (referred to as imaging-surface phase-difference AF hereinafter). An AF signal processing unit 204 (described below) performs a correlation operation for the pair of image signals to calculate a phase difference (referred to as an image shift amount hereinafter), which is a shift amount between the pair of image signals, and then calculates a defocus amount (and defocus direction) of the imaging optical system from the image shift amount.

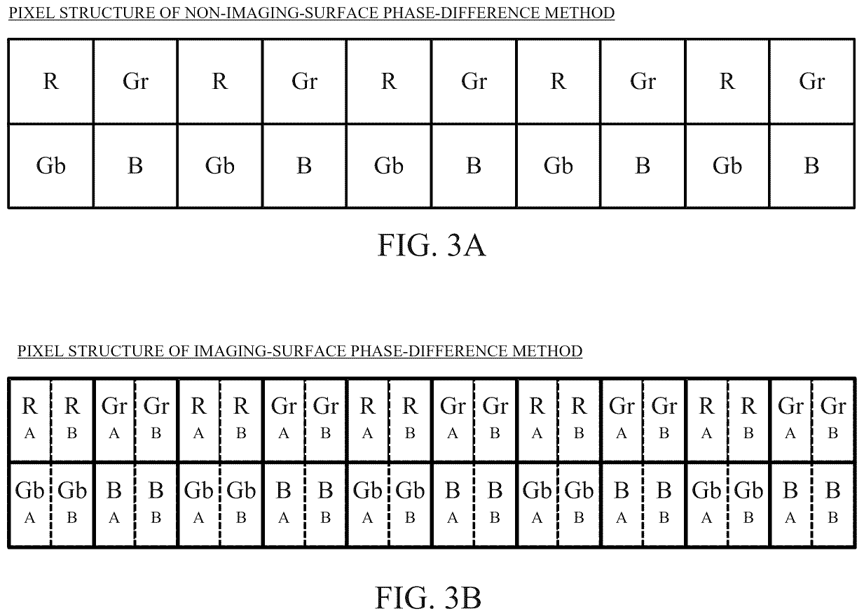

FIG. 3A illustrates the pixel structure of an image sensor that does not support the imaging-surface phase-difference AF. FIG. 3B illustrates the pixel structure of the image sensor 201 that supports the imaging-surface phase-difference AF. Both FIGS. 3A and 3B use the Bayer array, with R representing a red color filter, B representing a blue color filter, and Gr and Gb representing green color filters. In the pixel structure that supports imaging-surface phase-difference AF (FIG. 3B), two photodiodes A and B, which are divided into two in the horizontal direction in FIGS. 3A and 3B, are provided within a pixel that corresponds to one pixel (solid line area) in the pixel structure that does not support the imaging-surface phase-difference AF (FIG. 3B). The pixel dividing method illustrated in FIG. 3B is merely illustrative; the pixel may also be divided vertically, or divided into two in both the horizontal and vertical directions (a total of four divisions). The same image sensor may include multiple types of pixels divided using different division methods.

A converter (CDS/AGC/AD converter) 202 performs correlated double sampling to remove reset noise, gain control, and AD conversion for the AF signal and imaging signal read from the image sensor 201. The converter 202 outputs the processed imaging signal and AF signal to an image input controller 203 and the AF signal processing unit 204, respectively.

The image input controller 203 stores the imaging signal output from the converter 202 as an image signal in an SDRAM 209 via a bus 21. The image signal stored in the SDRAM 209 is read by a display control unit 205 via the bus 21 and displayed on a display unit 206. In a recording mode in which the image signal is recorded, the image signal stored in the SDRAM 209 is recorded by a recording-medium control unit 207 on a recording medium 208 such as a semiconductor memory.

A ROM 210 stores control programs and processing programs executed by the camera control unit 212, as well as various data required for their execution. A flash ROM 211 stores various setting information on the operation of the camera body 20 set by the user.

An object detector 2121 within the camera control unit 212 detects a specific object based on the imaging signal input from the image input controller 203 and determines the position of the specific object within the imaging signal. The object detector 2121 also continuously inputs imaging signals from the image input controller 203, and in a case where the detected specific object moves, the object detector 2121 determines the destination position and follows the position of the specific object. Examples of the specific object include a face object or an object located at a position designated by the user within the imaging screen using the camera operation unit 213. As will be described later, information on the position and size of the detected specific object is mainly used to set the area in which AF is performed.

The AF signal processing unit 204, which serves as a focus detecting apparatus, performs a correlation calculation for a pair of image signals, which are AF signals output from the converter 202, and calculates an image shift amount and reliability of the pair of image signals. The reliability is calculated using the degree of coincidence between the two images and the steepness of the correlation change amount, which will be described later. The AF signal processing unit 204 also sets the position and size of the focus detecting area, which is an area within the imaging screen where focus detection and AF are performed. The AF signal processing unit 204 outputs an image shift amount (detection amount) calculated in the focus detecting area and information on reliability to the camera control unit 212. Details of the processing performed by the AF signal processing unit 204 will be described later.

An AF control unit 2122 within the camera control unit 212 changes the settings for the AF signal processing unit 204 as necessary, based on the image shift amount and reliability calculated by the AF signal processing unit 204, and information indicating the state of the lens unit 10 and the camera body 20. For example, in a case where the image shift amount is equal to or greater than a predetermined amount for the AF signal processing unit 204, the area for the correlation calculation is set to be wider, and the type of bandpass filter is changed according to the contrast between the pair of image signals. In order to set the focus detecting area in the AF signal processing unit 204, the AF control unit 2122 sets the position and range of the focus detecting area using information on the position of a specific object detected by the object detector 2121 or a position specified on the imaging screen by the user using the camera operation unit 213.

The control apparatus according to this embodiment includes one or more memories storing instructions (such as the SDRAM 209, ROM 210, and flash ROM 211), and one or more processors that, upon execution of the instructions, operate to serve as the camera control unit 212 (object detector 2121 and AF control unit 2122). This is similarly applicable to the following other embodiments.

In this embodiment, a total of three signals are acquired from the image sensor 201: an imaging signal and a pair of image signals that are AF signals. Alternatively, for example, based on the load on the image sensor 201, two signals may be extracted: an imaging signal and one AF image signal, and use the difference between the extracted imaging signal and the AF image signal as the other AF image signal.

The camera control unit 212 controls each component within the camera body 20 by communicating information with them. According to an input from the camera operation unit 213 based on the user operation, the camera control unit 212 executes various processing according to the user operation, such as turning on and off the power, changing various settings, imaging processing, AF processing, and playback of recorded images. The camera control unit 212 also transmits control commands for the lens unit 10 (lens control unit 106) and information about the camera body 20 to the lens control unit 106, and also acquires information on the lens unit 10 from the lens control unit 106. The camera control unit 212 includes a microcomputer, and controls the entire camera system including the lens unit 10 by executing a computer program stored in the ROM 210. The camera control unit 212 calculates a defocus amount using the image shift amount in the focus detecting area calculated by the AF signal processing unit 204, and controls the driving of the focus lens 103 via the lens control unit 106 based on the defocus amount.

Next, the processing performed by the camera body 20 will be described. The camera control unit 212 performs the following processing in accordance with an imaging processing program, which is a computer program.

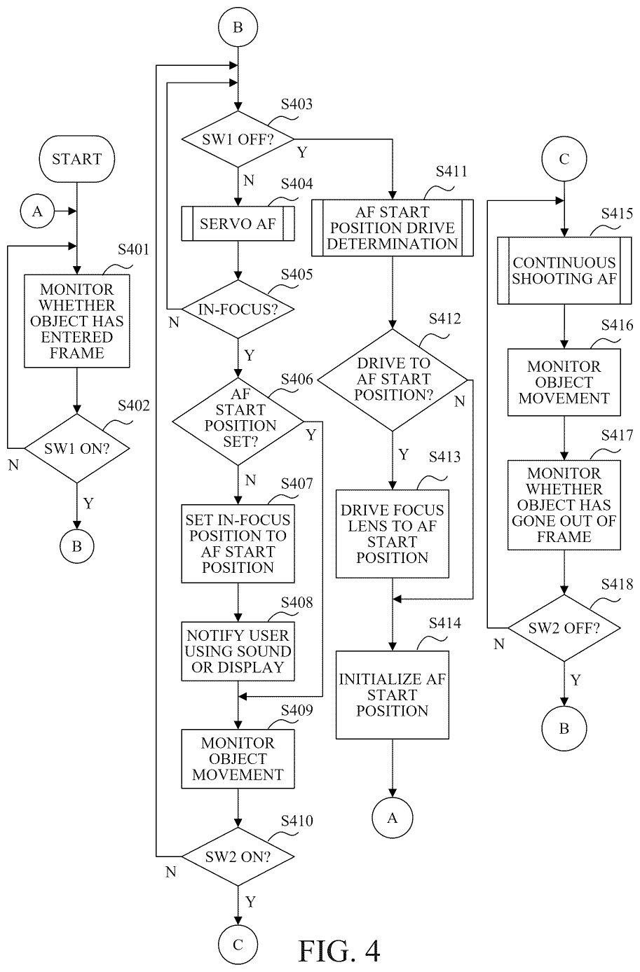

The imaging processing of the camera body 20, particularly the AF operation procedure performed by the camera control unit 212, will be described with reference to FIG. 4, assuming a workflow for mainly still image capturing. FIG. 4 is a flowchart of the AF operation according to this embodiment.

First, in step S401, the camera control unit 212 detects an object to be focused on based on the captured image using the object detector 2121 and monitors the movement direction of the detected object within the screen. The camera control unit 212 then monitors whether the detected object has entered the frame as the focus detecting area. The object can be a person, animal such as a dog or wild bird, or vehicle such as a motorcycle or automobile, as well as the main body parts of the object. Here, the main body parts refer to the eyes, face, or body of a person or animal, or the local body part of a vehicle. These detection methods use well-known technologies such as deep learning methods and image processing means, but as these are not the main topics in this disclosure, a detailed description thereof will be omitted.

Next, in step S402, the camera control unit 212 determines whether or not an instruction to start the AF operation by half-pressing the shutter button has been received from the camera operation unit 213 (whether or not SW1 is turned on). In a case where the instruction to start the AF operation has been received (in a case where SW1 is turned on), the flow proceeds to step S403, which represents the shutter button half-pressed state (state B). On the other hand, in a case where there is no instruction to start the AF operation (in a case where SW1 is not turned on), the flow returns to step S401, and the camera control unit 212 continues to monitor whether the object has entered the frame.

In the state B, first, in step S403, the camera control unit 212 determines whether or not the instruction to end the AF operation by releasing the shutter button half-press has been received from the camera operation unit 213. In a case where there is no instruction to end the AF operation and the AF operation will continue, the flow proceeds to step S404. On the other hand, in a case where there is the instruction to end the AF operation, the flow proceeds to step S411.

In step S404, the camera control unit 212 drives the focus lens 103 via the lens control unit 106 based on the output result of the focus detection processing by the AF signal processing unit 204, and executes servo AF, which continuously adjusts the focus on the object. In this embodiment, during the execution of the servo AF in step S404 and the continuous shooting servo AF of step S415 (described later) (during execution of the first processing), focus detection is performed for the entire imaging screen. The focus detection processing is processing for acquiring information on the defocus amount and reliability for the imaging-surface phase-difference AF. The area within the imaging screen from which information is acquired is also set according to the state of the camera body 20. Details of this processing will be described later.

Next, in step S405, the camera control unit 212 determines whether or not the servo AF in step S404 has been able to initially focus on the object (whether or not the object has been in focus, i.e., whether or not focusing has been completed). In a case where the object has been able to be focused at least once, the flow proceeds to step S406. On the other hand, in a case where the object has not yet been brought into focus, the flow proceeds to step S403, where the servo AF operation continues.

In step S406, the camera control unit 212 determines whether the AF start position, i.e., the position of the focus lens 103 based on the object that has entered the frame (first position), has been set. In a case where the AF start position has already been set, the flow proceeds to step S409. On the other hand, in a case where the AF start position has not yet been set, the flow proceeds to step S407.

In step S407, the camera control unit 212 sets the position of the focus lens 103 when focus is achieved by the servo AF in step S404 as the AF start position (first position). In this embodiment, the position where focus was initially achieved is set as the AF start position, the AF start position set using the history of the focus lens 103 in the servo AF of step S404, etc., may be properly changed.

Next, in step S408, the camera control unit 212 notifies the user by sound or display that the AF start position has been set (or of the information about the AF start position). In this embodiment, the user is notified by sound or display at the timing when the AF start position is set, the notification method is not limited to this example. Other methods or forms may be used as long as they can notify the user of information about the set AF start position, such as displaying information about the object distance corresponding to the AF start position on the display unit 206. The camera control unit 212 may notify the user of the information about the timing when the AF start position was set (at the timing when focusing was first completed).

Next, in step S409, the camera control unit 212 monitors how far the target object has moved in the optical axis direction during the servo AF of step S404. Next, in step S410, the camera control unit 212 determines whether or not an instruction to start a continuous shooting operation by fully pressing the shutter button has been received from the camera operation unit 213 (whether or not SW2 has been turned on). When the instruction to start the continuous shooting operation has been received (in a case where SW2 is turned on), the flow proceeds to step S415, where the shutter button is fully pressed (state C). On the other hand, when the instruction to start the continuous shooting operation has not yet been received (in a case where SW2 is turned off), the flow proceeds to step S403, where the operation continues with the shutter button half-pressed (state B).

In a case where it is determined in step S403 that an instruction to end the AF operation has been received, the camera control unit 212 determines in step S411 whether or not to drive the focus lens 103 to the AF start position set in step S407. Details of this will be described later.

Next, in step S412, the camera control unit 212 determines the result of the AF start position drive determination in step S411. In a case where it is determined to drive to the AF start position, the flow proceeds to step S413. On the other hand, in a case where it is determined not to drive to the AF start position, the flow proceeds to step S414.

In step S413, the camera control unit 212 drives the focus lens 103 to the AF start position set in step S407. This fixes the focus at the position where the last captured object was initially focused. Therefore, from the next time onwards, the camera can wait in a good focus state for an object that similarly enters the frame as the target area for focus detection, thereby improving the AF and imaging time lag and focusing accuracy. Next, in step S414, the camera control unit 212 initializes the AF start position information set in step S407. The flow then proceeds to step S401, where the shutter button is not pressed (state A).

In the state C, first, in step S415, the camera control unit 212 executes continuous shooting servo AF. That is, while performing continuous shooting, the camera control unit 212 drives the focus lens 103 via the lens control unit 106 based on the output result of the focus detection processing by the AF signal processing unit 204, and executes AF that continuously adjusts the focus on the object. The focus detection processing is basically the same as the servo AF in step S404, and thus a detailed description thereof will be omitted.

Next, in step S416, the camera control unit 212 monitors how far the target object has moved in the optical axis direction during the servo AF in step S404 and the continuous shooting servo AF in step S415. Next, in step S417, the camera control unit 212 monitors whether the object as a focusing target has gone out of frame of the imaging screen. This embodiment sets the entire imaging screen (the object detectable area) to the monitoring target area for going out of frame, but is not limited to this example. In a case where the target area for focus detection is not the entire imaging screen, the monitoring target area for going out of frame may be set to the target area for focus detection (the area used to acquire the focus state of the object (focus detecting area)). The camera control unit 212 can set the target area for focus detection to any area within the imaging screen, for example.

Next, in step S418, the camera control unit 212 determines whether or not an instruction to end the continuous shooting operation by releasing the shutter button from its fully pressed position has been received from the camera operation unit 213 (whether or not SW2 has been turned off). In a case where there is no instruction to end the continuous shooting operation and the continuous shooting operation is to continue (in a case where SW2 is turned on), the flow proceeds to step S415. On the other hand, in a case where there is an instruction to end the continuous shooting operation (in a case where SW2 is turned off), the flow proceeds to step S403 where the shutter button is half-pressed (state B).

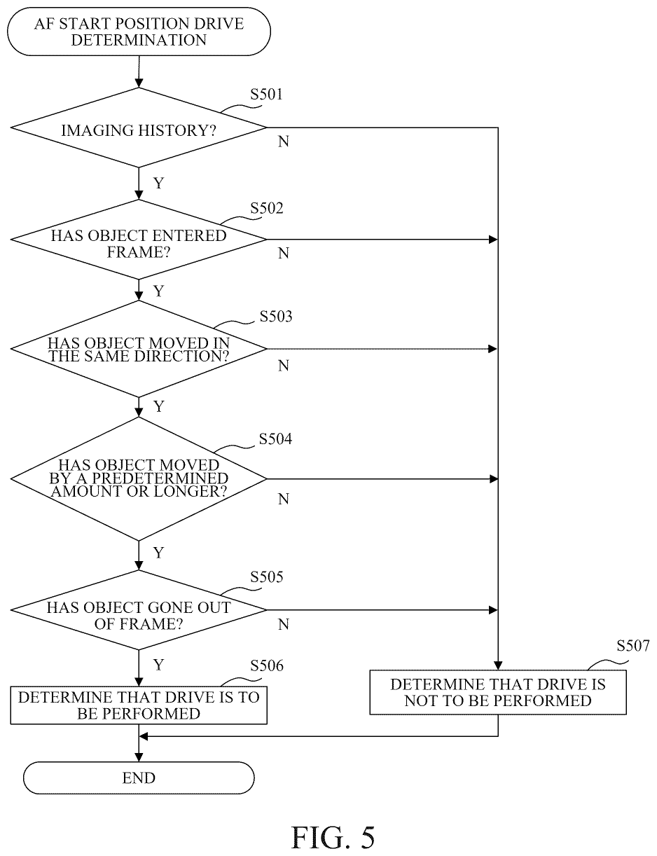

Next, the procedure for determining whether to drive to the AF start position in step S411 will be described with reference to FIG. 5. FIG. 5 is a flowchart of the AF start position drive determination.

First, in step S501, the camera control unit 212 determines whether or not there is an execution history of continuous shooting operation via the full pressing state of the shutter button (state C). In a case where there is the execution history of the continuous shooting operation, the flow proceeds to step S502. On the other hand, in a case where there is no history of the continuous shooting operation, the flow proceeds to step S507. In step S502, the camera control unit 212 determines, as a result of the monitoring in step S401, whether the object to be focused on has entered the frame as the target area for focus detection. In a case where the target object has entered the frame, the flow proceeds to step S503. On the other hand, in a case where the target object has not entered the frame, the flow proceeds to step S507.

In step S503, the camera control unit 212 determines, as a result of the monitoring in steps S409 and S416, whether the object has moved in the same direction during the servo AF in step S404 and the continuous shooting servo AF in step S415. For example, the camera control unit 212 determines whether the target object has moved in the same direction relative to the optical axis, such as consistently coming closer or consistently moving away. In a case where the target object has moved in the same direction, the flow proceeds to step S504. On the other hand, in a case where the target object has not moved in the same direction, the flow proceeds to step S507.

In step S504, the camera control unit 212 determines, as a result of the monitoring in steps S409 and S416, whether the target object has moved by a predetermined amount or longer during the servo AF in step S404 and the continuous shooting servo AF in step S415. In a case where the target object has moved by the predetermined amount or longer, the flow proceeds to step S505. On the other hand, in a case where the target object has not moved by the predetermined amount or longer, the flow proceeds to step S507. Here, the predetermined amount may include a threshold that is to be determined as an image plane change amount based on a ratio to the depth of focus, but the threshold may also be determined as the actual moving distance the object.

In step S505, the camera control unit 212 determines, as a result of the monitoring in step S417, whether the target object has gone out of frame of the imaging screen. In a case where the target object has gone out of frame, the flow proceeds to step S506. On the other hand, in a case where the target object has not gone out of frame, the flow proceeds to step S507. In this embodiment, the monitoring target area for going out of frame is set as the entire imaging screen, but this embodiment is not limited to this example. In a case where the target area for focus detection is not the entire imaging screen, the monitoring target area for going out of frame may be used as the target area for focus detection.

In step S506, based on the determinations made in steps S501 to S505, the camera control unit 212 determines in step S413 that the focus lens 103 is to be driven to the AF start position set in step S407. In step S507, based on the determinations made in steps S501 to S505, the camera control unit 212 determines in step S413 that the focus lens 103 is not to be driven to the AF start position set in step S407.

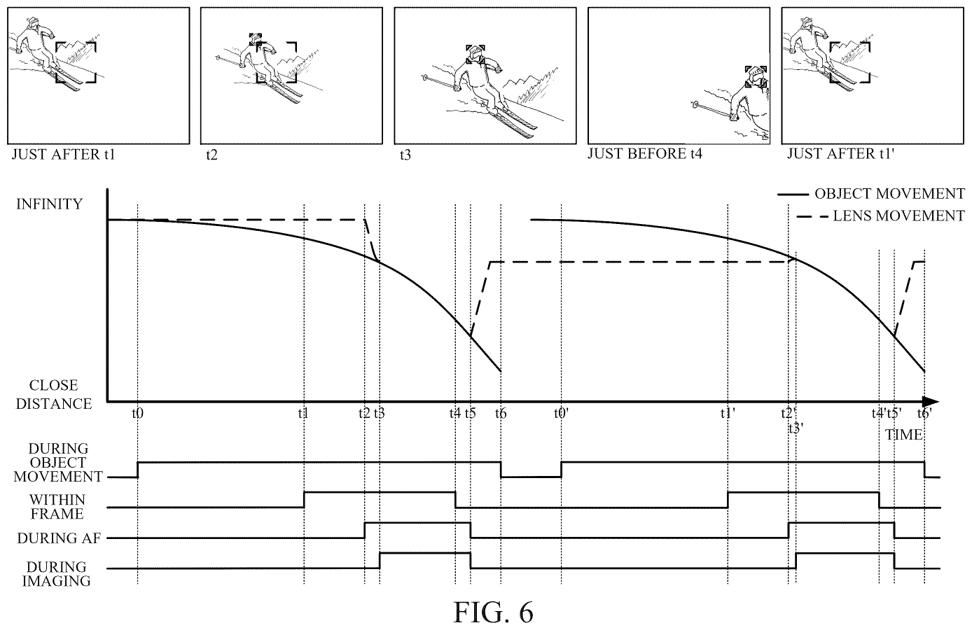

Referring now to FIG. 6, a description will be given of the chronological movements of the object and lens in a case where the AF operation described with reference to FIGS. 4 and 5 is applied. FIG. 6 is a timing chart illustrating the effects of this embodiment.

In FIG. 6, times t0 to t5 in the first imaging are the same as those in FIG. 2. On the other hand, by driving the focus lens 103 to the initial in-focus position when imaging and AF are stopped at time t5, when the object again enters the frame within the angle of view at time t1′ during the second or subsequent imaging, the camera control unit 212 can stand by in a good focus state. This configuration can improve the time lag and focus accuracy of AF and imaging from time t2′ to time t3′.

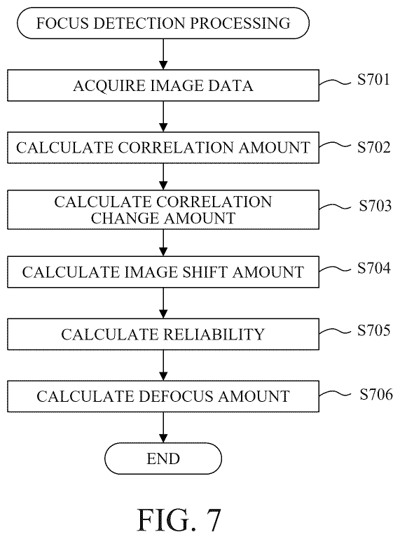

Referring now to FIG. 7, a detailed description will be given of the focus detection processing performed by the AF signal processing unit 204 in the servo AF of step S404 and the continuous shooting servo AF of step S415. FIG. 7 is a flowchart of the focus detection processing.

First, in step S701, the AF signal processing unit 204 acquires a pair of image signals as AF signals from a plurality of pixels included in the focus detecting area (AF area) of the image sensor 201.

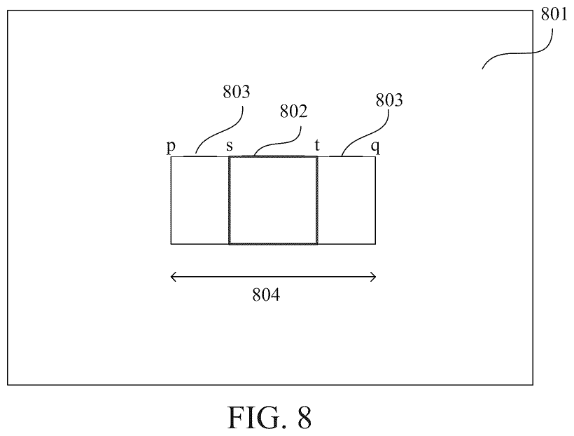

FIG. 8 illustrates an example of a focus detecting area 802 on a pixel array 801 of the image sensor 201. Shift areas 803 on both sides of the focus detecting area 802 are areas for correlation calculations. Therefore, an area 804, which is a combination of the focus detecting area 802 and shift areas 803, is a pixel area for correlation calculation. In FIG. 8, each of p, q, s, and t represents a coordinate in the horizontal direction (x-axis direction), with p and q respectively representing the x-coordinates of the start and end points of the area (pixel area) 804, and s and t respectively representing the x-coordinates of the start and end points of the focus detecting area 802.

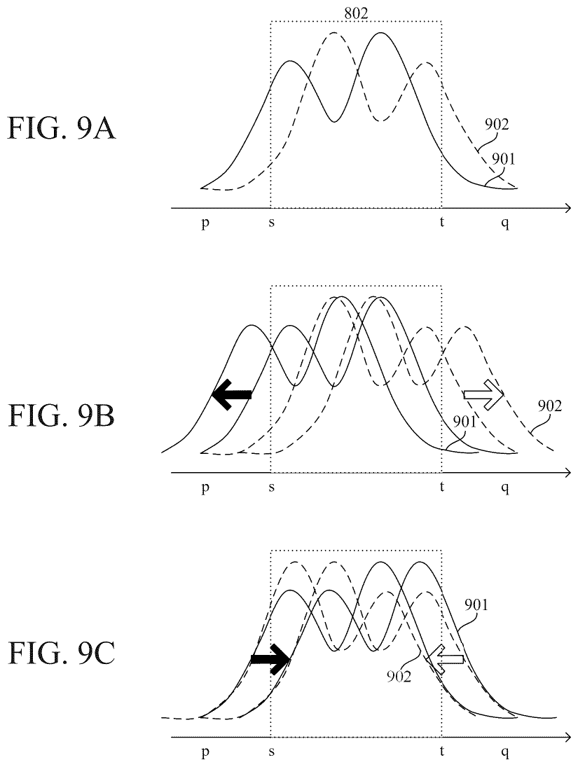

FIGS. 9A, 9B, and 9C illustrate examples of a pair of AF image signals acquired from the plurality of pixels included in the focus detecting area 802 illustrated in FIG. 8. A solid line 901 represents one image signal A, and a broken line 902 represents the other image signal B. FIG. 9A illustrates image signals A and B before shifting. FIGS. 9B and 9C illustrate the states where image signals A and B have been shifted in the positive and negative directions, respectively, from the state illustrated in FIG. 9A.

Next, in step S702 of FIG. 7, the AF signal processing unit 204 calculates a correlation amount between the pair of acquired image signals while relatively shifting the pair of image signals by one pixel (one bit) at a time. For each of multiple pixel lines (scanning lines) provided within the focus detecting area, the correlation amount between the pair of image signals A901 and B902 is calculated by shifting both the image signals A901 and B902 by one bit in the arrow direction as illustrated in FIGS. 9B and 9C. Then, a single correlation amount is calculated by averaging the correlation amounts. Here, the pair of image signals are relatively shifted by one pixel at a time to calculate the correlation amount, but a configuration in which the shift is made in more pixel units, such as by shifting two pixels at a time, may also be used. A single correlation amount is calculated by averaging the correlation amounts on each scanning line, but a configuration for averaging the pair of image signals on each scanning line and then calculating the correlation amount for the pair of image signals acquired by averaging may also be used. Let the shift amount be i, the minimum shift amount be p-s, the maximum shift amount be q-t, x be the start coordinate of the focus detecting area 802, and y be the end coordinate of the focus detecting area 802. The correlation amount COR can be calculated using the following equation (1):

$$COR [ i ] = {\sum }_{k = x}^{y} \vert A [ k + i ] - B [ k - i ] \vert \qquad ( 1 )$$

$$\{ ( p - s ) < i < ( q - t ) \}$$

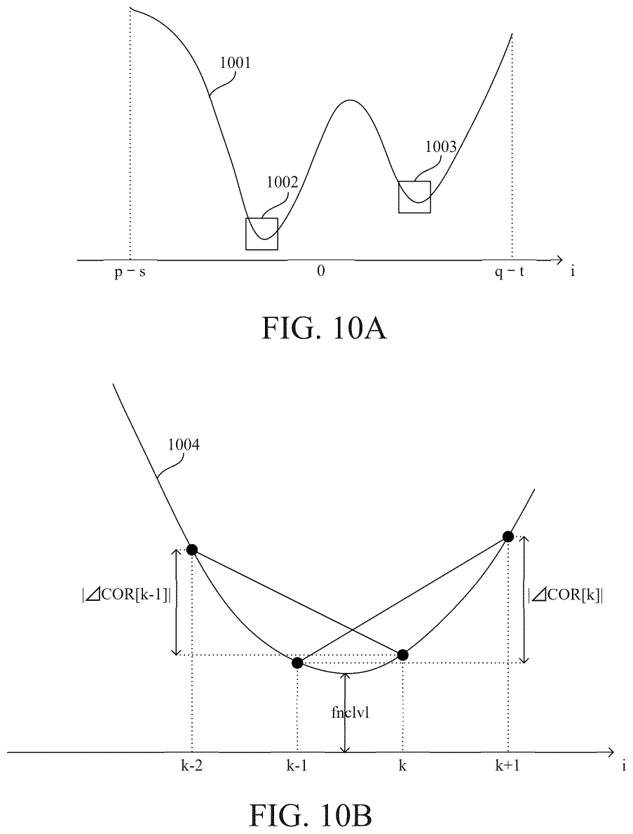

FIG. 10A illustrates an example of a relationship between the shift amount and the correlation amount COR. In FIG. 10A, a horizontal axis represents a shift amount, and a vertical axis represents a correlation amount COR. Among areas 1002 and 1003 near the extreme values of a correlation amount 1001, which changes with the shift amount, the degree of coincidence between the pair of image signals A and B is highest at the shift amount corresponding to the smaller correlation amount.

Next, in step S703 of FIG. 7, the AF signal processing unit 204 calculates the correlation change amount from the correlation amount calculated in step S702. The correlation change amount is calculated as the difference between the correlation amounts for every other shift in the waveform of the correlation amount 1001 illustrated in FIG. 10A. If the shift amount is i, the minimum shift amount is p-S, and the maximum shift amount is q-t, the correlation change amount ΔCOR can be calculated using the following equation (2):

$$Δ COR [ i ] = COR [ i - 1 ] - COR [ i + 1 ] \qquad ( 2 )$$

$$\{ ( p - s + 1 ) < i < ( q - t - 1 ) \}$$

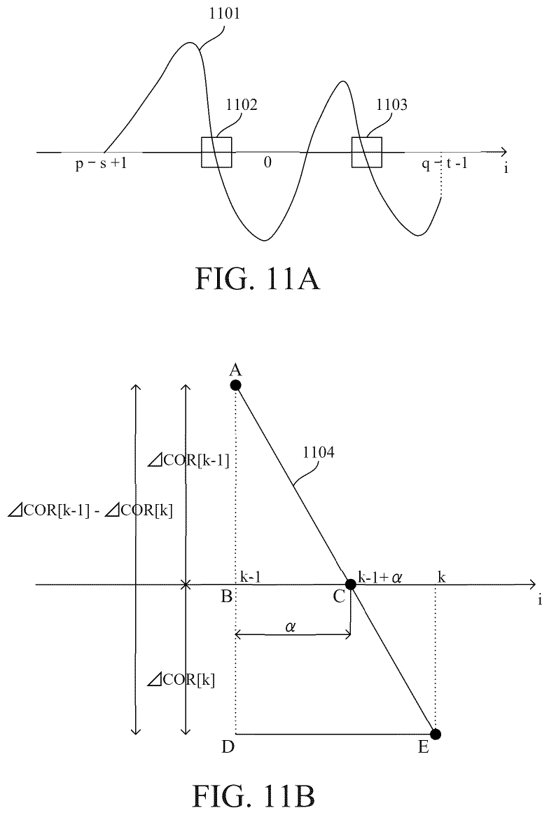

Next, in step S704, the AF signal processing unit 204 calculates the image shift amount using the correlation change amount calculated in step S703. FIG. 11A illustrates an example of a relationship between the shift amount and the correlation change amount ΔCOR. In FIG. 11A, a horizontal axis represents a shift amount, and a vertical axis represents a correlation change amount ΔCOR. A correlation change amount 1101, which changes with a shift amount, goes from positive to negative in areas 1102 and 1103. The state when the correlation change amount is 0 is called a zero crossing, and is the state where the pair of image signals A and B coincide most closely. Therefore, the shift amount that gives the zero crossing is the image shift amount.

FIG. 11B is an enlarged view of the area 1102 in FIG. 11A. Reference numeral 1104 is a part of the correlation change amount 1101. The shift amount (k−1+α) that gives the zero crossing is divided into an integer part β(=k−1) and a decimal part α. The decimal part α can be calculated using the following equation (3) based on the similarity relationship between triangles ABC and ADE in FIG. 11B:

$$AB : AD = BC : DE \qquad ( 3 )$$

$$Δ COR [ k - 1 ] : Δ COR [ k - 1 ] - Δ COR [ k ] = α : k - ( k - 1 )$$

$$α = \frac{Δ COR [ k - 1 ]}{Δ COR [ k - 1 ] - Δ COR [ k ]}$$

The integer portion β can be calculated from FIG. 11B using the following equation (4):

$$β = k - 1 \qquad ( 4 )$$

In other words, the image shift amount PRD can be calculated from the sum of α and β. As illustrated in FIG. 11A, in a case where there are multiple zero crossings of the correlation change amount ΔCOR, the one with the steepest change in the correlation change amount ΔCOR nearby is considered the first zero crossing. This steepness is an indicator of the ease of AF, and a higher value indicates a point where accurate AF can be achieved. The steepness maxder can be calculated using the following equation (5):

$$max d er = \vert Δ COR [ k - 1 ] \vert + \vert Δ COR [ k ] \vert \qquad ( 5 )$$

In this embodiment, if there are multiple zero crossings in the correlation change amount, the first zero crossing is determined based on its steepness, and the shift amount that gives the first zero crossing is defined as the image shift amount.

Next, in step S707, the AF signal processing unit 204 calculates the reliability, which indicates the reliability of the image shift amount calculated in step S704. The reliability of the image shift amount can be defined by the degree of coincidence between the pair of image signals A and B (referred to as a two-image coincidence degree) fnclvl and the steepness of the correlation change amount described above. The two-image coincidence degree is an index that indicates the accuracy of the image shift amount; here, the smaller its value, the better the accuracy. FIG. 10B is an enlarged view of the area 1002 in FIG. 10A, with reference numeral 1004 representing a part of the correlation amount 1001. The two-image coincidence degree fnclvl can be calculated using the following equation (8):

$$\begin{matrix}( i ) & \\ fnclvl = COR [ k - 1 ] + Δ COR [ k - 1 ] / 4 & ( 6 )\end{matrix}$$

if|ΔCOR[k−1]|×2≤maxder

$$\begin{matrix}( ii ) & \\ fnclvl = COR [ k ] + Δ COR [ k ] / 4 & ( 7 )\end{matrix}$$

### if |ΔCOR[k−1]|×2>maxder

Finally, in step S708, the AF signal processing unit 204 calculates the defocus amount of the focus detecting area using the image shift amount of the focus detecting area calculated in step S704.

As described above, in this embodiment, in a case where the focus lens 103 moves from the first position to the second position and the object moves outside the first area during imaging, the AF control unit 2122 moves the focus lens 103 from the second position to the first position. For example, the second position is an arbitrary position different from the first position. The AF control unit 2122 may store a first position of the focus lens based on the object that has entered a frame in the first area. In a case where the focus lens 103 moves from the first position to the second position because the focus lens 103 moves by a predetermined distance or longer and the object has gone out of frame as the first area during imaging, the AF control unit 2122 moves the focus lens 103 to the first position when imaging ends. The first position can be stored, for example, in the internal memory of the camera control unit 212, but this embodiment is not limited to this example and the position can also be stored in another memory.

By using the imaging history of the last object to perform preparations for the next imaging, this embodiment can achieve proper focusing, especially in repeatedly capturing an image of a moving object.

In this embodiment, the AF operation procedure assumes a still image capturing workflow, but this embodiment is not limited to this example. This embodiment can also be applied to automatic imaging that does not need user operation.

For example, the AF control unit 2122 may be able to execute first processing (first focusing control) and second processing (second focusing control). The first processing is processing that starts control of the focus lens 103 in response to an instruction from the camera operation unit 213 by user operation, such as processing regarding to still image AF. The second processing is processing that automatically starts control of the focus lens 103 for an object without an instruction from the camera operation unit 213, such as processing regarding moving image AF.

In this embodiment, the first position may be the position of the focus lens 103 when focusing is first completed. In the first processing, the focus state can be acquired across the entire imaging screen. The AF control unit 2122 notifies the user of information on the timing at which focusing was first completed. When an instruction to start capturing still or moving images is automatically issued, the AF control unit 2122 moves the focus lens 103 to the first position when imaging is completed.

### Second Embodiment

Next, a second embodiment according to the disclosure will be described. This embodiment will omit a description of configurations and operations common to those of the first embodiment.

First, the processing performed by the camera body 20 will be described. The camera control unit 212 performs the following processing in accordance with an imaging processing program, which is a computer program.

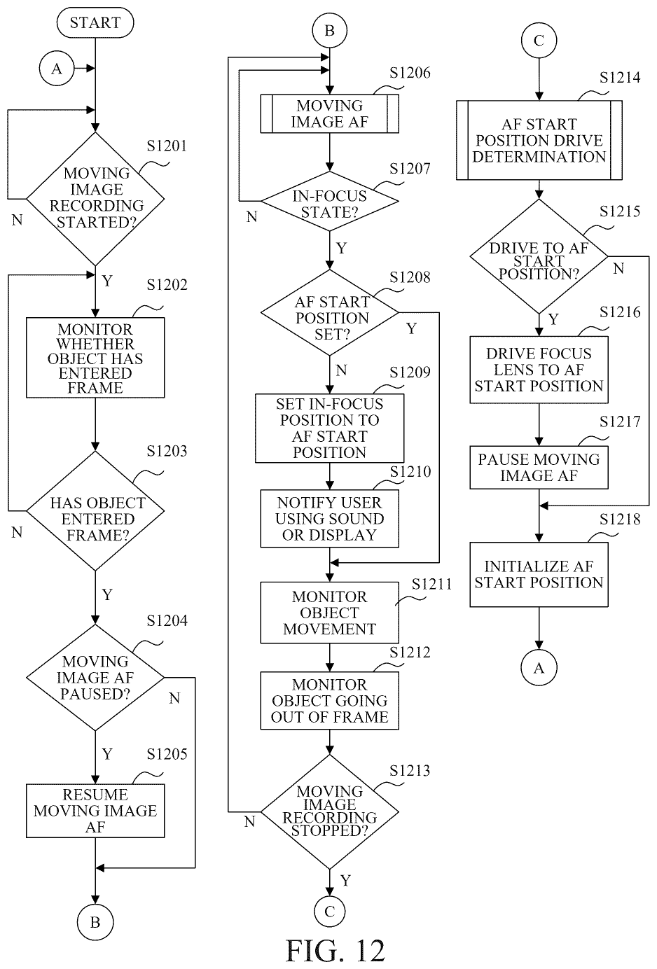

Referring to FIG. 12, the imaging processing of the camera body 20, particularly the AF operation performed by the camera control unit 212, will be described, assuming a mainly moving image capturing workflow. FIG. 12 is a flowchart of the AF operation according to this embodiment.

First, in step S1201, the camera control unit 212 determines whether or not an instruction to start capturing a moving image (recording a moving image) has been received from the camera operation unit 213 by pressing the moving image recording button. In a case where the instruction to start capturing a moving image has been received, the flow proceeds to step S1202. On the other hand, in a case where the instruction to start capturing a moving image has not been received, the camera control unit 212 waits for that instruction.

In step S1202, the camera control unit 212 detects an object to be focused on from the captured image using the object detector 2121. The camera control unit 212 also monitors a moving direction of the target object within the screen, and monitors whether the target object has entered the frame as the target area for focus detection. Here, the object can be a person, a dog, an animal such as a wild bird, or a vehicle such as a motorcycle or automobile, and it is possible to detect the main body part of the target object. Here, the main body part refers to the pupils, face, or body of a person or animal, or a local part of a vehicle or the body. These detection methods can use well-known technologies such as deep learning technologies and image processing means, but as they are not the main topics in this disclosure, a detail description thereof will be omitted. This embodiment performs focus detection on the entire imaging screen, but is not limited to this example.

Next, in step S1203, the camera control unit 212 determines whether or not the target object of focusing has entered a frame as the target area for focus detection as a result of the monitoring in step S1201. In a case where the target object has entered the frame, the flow proceeds to step S1204. On the other hand, in a case where the target object has not entered the frame, the flow proceeds step S1202 and continues to monitor whether the object has entered the frame.

In step S1204, the camera control unit 212 determines whether or not the moving image AF operation has been paused in step S1217, which will be described later. In a case where the moving image AF operation is paused, the flow proceeds to step S1204. On the other hand, in a case where the moving image AF operation is not paused, the flow proceeds to step S1206 in the state B. In step S1205, the camera control unit 212 resumes the moving image AF operation that was paused in step S1217, which will be described later, and the flow proceeds to S1206 in the state B.

In the state B, first in step S1206, the camera control unit 212 executes moving image AF (second processing). That is, the camera control unit 212 drives the focus lens 103 via the lens control unit 106 based on the output result of the focus detection processing by the AF signal processing unit 204, and executes AF that continuously perform focusing on the target object. The focus detection processing is processing that acquires information on the defocus amount and reliability for imaging-surface phase-difference AF, and also sets the area within the imaging screen from which information is acquired according to the state of the camera body 20. The details here are the same as those in the first embodiment, and thus a description thereof will be omitted.

Next, in step S1207, the camera control unit 212 determines whether or not the moving image AF of step S1206 was able to initially focus on the object (whether or not an in-focus state has been achieved, i.e., whether or not focusing has been completed). In a case where the in-focus state has been achieved even once, the flow proceeds to step S1208. On the other hand, in a case where the in-focus state has not yet been achieved even once, the flow proceeds to step S1206, where the camera control unit 212 continues the moving image AF operation.

In step S1208, the camera control unit 212 determines whether or not the AF start position (first position) has been set in step S1209, which will be described later. In a case where the AF start position has been set, the flow proceeds to step S1211. On the other hand, if the AF start position has not yet been set, the flow proceeds to step S1209.

In step S1209, the camera control unit 212 sets the position of the focus lens 103 when the in-focus state was achieved by moving image AF in step S1206 as the AF start position (first position). In this embodiment, the position where the in-focus state was first achieved is set as the AF start position, this embodiment is not limited to this example. The AF start position set using the history of the focus lens 103 during moving image AF in step S1206 may be properly changed.

Next, in step S1210, the camera control unit 212 notifies the user by sound or display that the AF start position has been set. In this embodiment, the user is notified by sound or display at the timing when the AF start position is set, but this embodiment is not limited to this example. Other means or forms may be used as long as it is possible to notify the user of information regarding the set AF start position, such as displaying corresponding object distance information on the display unit 206.

Next, in step S1211, the camera control unit 212 monitors how far the target object has moved in the optical axis direction during the moving image AF in step S1206. Next, in step S1212, the camera control unit 212 monitors whether the target of focusing has gone out of the frame and outside the imaging screen. This embodiment sets the monitoring target area for going out of frame to the entire imaging screen, but is not limited to this example. In a case where the target area for focus detection is not the entire imaging screen, the monitoring target area for going out of frame (first area) may be set to the target area for focus detection.

Next, in step S1213, the camera control unit 212 determines whether or not an instruction to end the moving image capturing operation (an instruction to stop recording a moving image) has been received from the camera operation unit 213 by pressing the moving image recording button. In a case where there is no instruction to end the moving image capturing operation and the moving image capturing operation is to continue, the flow proceeds to step S1206. On the other hand, in a case where there is the instruction to end the moving image capturing operation, the flow proceeds to step S1214 in the state C.

In the state C, first, in step S1214, the camera control unit 212 determines whether or not to drive the focus lens 103 to the AF start position set in S1209. This processing is the same as that in the first embodiment, and thus a description thereof will be omitted.

Next, in step S1215, the camera control unit 212 determines whether or not the focus lens 103 is to be driven to the AF start position, based on the determination result of the AF start position drive determination in step S1214. In a case where it is determined that the focus lens 103 is to be driven to the AF start position, the flow proceeds to step S1216. In a case where it is determined that the focus lens 103 is not to be driven to the AF start position, the flow proceeds to step S1218.

In step S1216, the camera control unit 212 drives the focus lens 103 to the AF start position set in step S1209. Next, in step S1217, the camera control unit 212 pauses the moving image AF (second processing). This prevents the camera from being accidentally focused on an unintended object before the next object to be captured enters the frame. This fixes the focus at the position where the in-focus state was initially achieved for the last captured object. Therefore, from the next time onwards, the camera can wait in a good focus state for an object that similarly enters the frame in the target area for focus detection, thereby improving the AF time lag and focusing accuracy. Next, in step S1218, the camera control unit 212 initializes the AF start position information set in step S1209. The flow then proceeds to step S1201 in the state A.

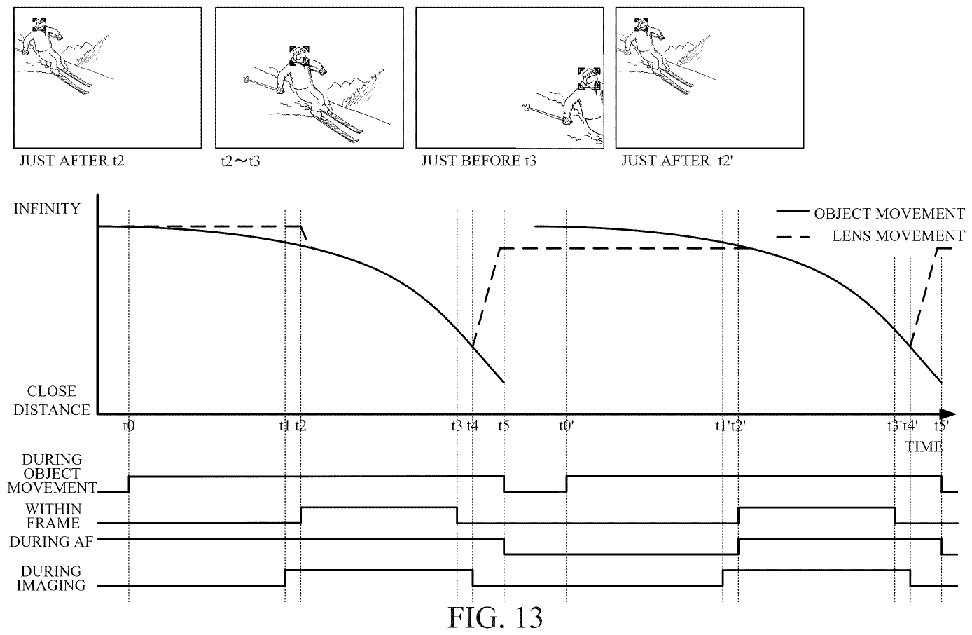

Next, with reference to FIG. 13, the chronological movements of the object and lens in a case where the AF operation described with reference to FIG. 12 is applied will be described. FIG. 13 is a timing chart illustrating the effects of this embodiment.

During the first imaging, the initial in-focus position when the object enters a frame within the angle of view at time t2 is set as the AF start position (first position). When imaging is stopped at time t4, the focus lens 103 is driven to the above AF start position, and then the moving image AF operation is stopped. Thereby, the camera can wait in good focus state for an object that enters a frame within the angle of view again at time t2′ during the second or subsequent imaging. That is, in this embodiment, during moving image AF (second processing), the AF control unit 2122 temporarily stops moving image AF after moving the focus lens 103 to the first position when imaging ends, and then starts moving image AF when the object again enters a frame as the first area. Therefore, the AF time lag and focus accuracy can be improved.

Thus, using the last imaging history of the object to perform preparation operations for the next imaging, this embodiment can achieve proper focusing, particularly in repeatedly capturing an image of a moving object. In this embodiment, the AF operation procedure assumes a moving image capturing workflow, but this embodiment can also be applied to automatic imaging that does not need user operation.

Each embodiment can provide a control apparatus, image pickup apparatus, control method, and a storage medium, each of which can achieve proper focus control in repeatedly capturing an image of a moving object.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-217738, which was filed on Dec. 12, 2024, and which is hereby incorporated by reference herein in its entirety.

What is claimed is:

1. A control apparatus comprising:
one or more memories storing instructions; and
one or more processors that, upon execution of the instructions, operate to:
detect an object using a signal output from an image sensor,
control a focus lens according to a focus state of the object,
store a first position of the focus lens according to the focus state of the object in a first area, and
in a case where the focus lens moves from the first position to a second position and the object moves outside the first area during imaging, move the focus lens from the second position to the first position.

2. The control apparatus according to claim 1, wherein the one or more memories store the first position of the focus lens based on the object that has entered a frame as the first area, and
wherein in a case where the focus lens moves from the first position to the second position because the focus lens moves by a predetermined distance or longer and the object has gone out of frame as the first area during imaging, the one or more processors operate to move the focus lens to the first position when imaging ends.

3. The control apparatus according to claim 1, wherein the first area is an area for acquiring the focus state of the object.

4. The control apparatus according to claim 1, wherein the first area is a detectable area of the object.

5. The control apparatus according to claim 1, wherein the one or more processors operate to execute:
first processing for starting control of the focus lens according to an instruction from an operation unit operable by a user, and
second processing for automatically starting the control of the focus lens for the object.

6. The control apparatus according to claim 1, wherein the first position is a position of the focus lens when focusing is first completed.

7. The control apparatus according to claim 5, wherein the first processing can acquire the focus state on an entire imaging screen.

8. The control apparatus according to claim 5, wherein the one or more processors operate to:
temporarily stop the second processing after moving the focus lens to the first position when imaging is completed in the second processing, and
start the second processing when the object again enters a frame as the first area.

9. The control apparatus according to claim 1, wherein the one or more processors operate to move the focus lens to the first position when imaging is completed in a case where the focus lens moves in the same direction during imaging.

10. The control apparatus according to claim 1, wherein the one or more processors operate to notify a user of information on the first position.

11. The control apparatus according to claim 1, wherein the one or more processors operate to notify a user of information on a timing when focusing was first completed.

12. The control apparatus according to claim 1, wherein the one or more processors operate to display an object distance corresponding to the first position on a display unit.

13. The control apparatus according to claim 1, wherein the one or more processors operate to move the focus lens to the first position when imaging is completed in a case where an imaging start is automatically instructed.

14. An Image pickup apparatus comprising:
a control apparatus; and
an image sensor,
wherein the control apparatus includes:
one or more memories storing instructions, and
one or more processors that, upon execution of the instructions, operate to:
detect an object using a signal output from the image sensor,
control a focus lens according to a focus state of the object,
store a first position of the focus lens according to the focus state of the object in a first area, and
in a case where the focus lens moves from the first position to a second position and the object moves outside the first area during imaging, move the focus lens from the second position to the first position.

15. The image pickup apparatus according to claim 14, further comprising an optical system including the focus lens.

16. A control method comprising:
detecting an object using a signal output from an image sensor;
controlling a focus lens according to a focus state of the object;
storing a first position of the focus lens according to the focus state of the object in a first area; and
moving, in a case where the focus lens moves from the first position to a second position and the object moves outside the first area during imaging, the focus lens from the second position to the first position.

17. A non-transitory computer-readable storage medium storing a program for causing a computer to execute the control method according to claim 16.
